(19) United States
(12) Patent Application Publication
(10) Pub. No.: US 2020/0341987 A1
(43) Pub. Date: Oct. 29, 2020

(54) RANKING DATABASE QUERY RESULTS

(71) Applicant: MICROSOFT TECHNOLOGY LICENSING, LLC, Redmond, WA (US)

(72) Inventor: Ian Paul Wright, Oxford (GB)

(21) Appl. No.: 16/394,523

(22) Filed: Apr. 25, 2019

(51) Int. Cl. G06F 16/2457; G06N 20/00

(52) U.S. Cl. CPC G06F 16/24578; G06N 20/00

(57) ABSTRACT

Methods, systems, and apparatus, including computer programs encoded on computer storage media, for database query ranking. One of the methods includes receiving a query having a plurality of predicates; executing the query comprising executing the plurality of predicates to generate a plurality of tuple values; generating a query derivation graph for the query generating, from the query derivation graph, a plurality of feature values for each query result of the plurality of query results; computing a score for each query result of the plurality of query results by using the plurality of feature values generated for the query result as input to a trained ranking model; and ranking the plurality of query results according to computed scores generated by the trained ranking model.

### BACKGROUND

This specification relates to processing database queries.

Databases can store tuples of data in one or more relations. In this specification, a relation is a set of tuples, with each tuple having one or more elements that each correspond to a respective attribute of the relation. For convenience, database relations are often referred to as tables, although the tuples belonging to a relation can be stored in any appropriate form, and a relation being referred to as a table does not imply that its tuples are stored contiguously or in tabular form.

Database management systems can process queries in order to retrieve query results that satisfy queries. The sheer number of query results generated for databases can be overwhelming, particularly for very large databases. The query results may be presented in no particular order, or in an order that does not reflect the relevance each query result has for the user, a property which might be unknown at the time that the query is written or processed.

Consider a very large database storing people's names, ages and locations, a portion of which is illustrated in TABLE 1:

TABLE 1

| Person | ID | Age | Location |
|---|---|---|---|
| Aaron | 6000 | 49 | south |
| Abby | 3000 | 24 | east |
| Abdul | 4300 | 37 | west |
| . . . | . . . | . . . | . . . |
| . . . | . . . | . . . | . . . |
| Wilson | 9000 | 27 | north |

An example query for obtaining names of people having the location attribute value “south” and who are less than 40 years old is shown in TABLE 2.

TABLE 2

| | |
|---|---|
| 1 | from Person person |
| 2 | where person.getLocation( ) = “south” and person.getAge( ) < 40 |
| 3 | select person, person.getID( ) |

On a very large database, the example query shown in TABLE 2 may return lots and lots of results. Eleven example results are shown in TABLE 3:

TABLE 3

| Person | ID |
|---|---|
| Almira | 1800 |
| Bruce | 400 |
| Charlie | 1500 |
| George | 1500 |
| Ira | 6600 |
| Laura | 1400 |
| Maya | 1100 |
| Milton | 7800 |
| Nala | 9400 |
| Simba | 9300 |
| Sylvester | 8600 |

The query author's intent may be to identify the names of people under the age of forty, who live in the south. But a user executing the query may be different than the query author, and therefore may have more specific preferences for query results than anticipated by the query writer. For example, suppose a user's intention in executing the query shown in TABLE 2 was to identify people under the age of forty, living in the south, and who have “fashionable” names. The condition of having a fashionable name is unknown to the database system and the query writer at the time the query in TABLE 2 was written. Therefore, just from the query and the query results themselves, there is no way for the database system to generate a ranking that matches the user's specific preferences.

It is possible to machine learn a model from query users' feedback to predict the rank of query results according to query users' preferences. In this way, queries can be automatically adapted to users' preferences without having to rewrite the queries.

Machine learning refers to techniques for learning parameters of a model from training data in order to reduce an error among the training examples for a particular kind of prediction. Common types of machine learning models include ranking models that generate a ranking when given features for a particular input example. Some ranking models learn complex nonlinear functions of multiple features in order to make predictions.

However, using attribute values alone to make predictions often results in poor ranking results. For example, in this dataset, younger people tend to have more fashionable names. Therefore, if using the “age” attribute values to train a ranking model, the ranking model may simply determine that all young people have fashionable names.

Overly voluminous and poorly ranked query results are more than a mere annoyance in many industries. For example, in the field of source code analysis, queries can be used to automatically identify coding defects in code bases. Developers can use the query results to then address problems in the code base. But not all coding defects are equally important.

A single query can identify a particular type of coding defect. Some query results of the query might be highly important coding defects, which must be fixed immediately; while others might be less important, and can be ignored or addressed later; and still other coding defects may actually be false positives and not relevant to a developer at all. Query users often have deep knowledge of their code with accompanying complex preferences over which query results they would like to see returned by a query. These preferences may be unknown to the query author, or otherwise difficult-to-express by the query author who has knowledge of the user preferences.

Therefore, the technical stability, security, and maintainability of the source code base is closely tied to the ability for developers to quickly and easily distinguish important query results from unimportant query results. When developers spend time parsing through unimportant coding defects, the efficiency of the development process, as well as the overall technical quality of the code base, degrades.

### SUMMARY

This specification describes how a database system can automatically rank query results obtained from executing a query on a database by learning a model that reflects user's feedback on the relevance of query results. In particular, the system can use features from query derivation graphs to predict the user's belief of the relevance of different query results. A query derivation graph represents the partial or complete data-flow path for each query result in a set of query results.

In general, queries and the data they act upon, implicitly contain information that is predictive, in a statistical sense, of the users' preferences. For example, queries, in general, are complex programs that combine many intermediate logical operations on subsets of information in the database before returning the final query results to the user. The kinds of intermediate operations performed during query execution, and the subsets of information analyzed (collectively, a “query derivation graph”) may all be used to construct features for machine learning models that aim to rank the final results in an order that more closely reflects users' preferences. For example, in the dataset shown in TABLE 1, above, younger people tend to have more fashionable names. Therefore, the “age” attribute is a weakly predictive of “fashionable” and can therefore be used as a feature to help train a ranking model.

A predictive model can thus be trained from query derivation graph features from user feedback on query results generated for a particular query. The trained predictive model can then be used to generate a ranking of query results based on learned preferences of users executing the query. The predictive model can receive continuous feedback from users executing the query at different times and on different databases to update how the model ranks query results as the model learns the users' preferences and how the preferences may change over time.

Users can provide feedback after obtaining query results. A user can provide feedback by scoring query results numerically, e.g., 1 for most important, 2 for second most important, and so on; or categorically, e.g., a query result can be labeled “relevant” or “irrelevant” to a user executing the query. A feature vector can be obtained for each query result and labeled according to a respective label provided by user feedback for the query result. The labeled feature vector can be provided as input to the predictive model to train the model to better classify the relevance of a new query result.

The subject matter described in this specification can be implemented in particular embodiments so as to realize one or more of the following advantages:

A database system can automatically rank query results by user relevance to prioritize results that are more important to a user executing the query on a database. By ranking query results, users' time is saved because users can address the important results instead of wasting time wading through a large set of query results to search for relevant results first. False positives in the query results can be eliminated or ranked lower than relevant query results, and in general query results of a lower predicated relevance can be ordered below query results of a higher predicted relevance. Users can more easily review even very large lists of query results because the query results are ranked according to user preferences.

User preferences are typically unknown or difficult to code at the time a query is written, but the system can learn preferences from user feedback without query writers having to re-write any query and without substantive changes to the system. In addition, as user preferences shift over time, the system can learn these shifted preferences automatically.

Training a ranking model with training data labeled by user feedback can improve the query result ranking by embodying a user community's collective knowledge. For example, in the domain of static code analysis, the same queries can be applied to many different databases that represent code bases of different software projects. Feedback from developers of these different software projects can be used to train a model to rank query results to prioritize the most relevant results first. In practice, more experienced and proficient developers for one project can provide feedback that the system can later use to train a model that ranks query results for the benefit of developers of other projects.

The system can obtain feedback of users executing queries, which can be used to continuously improve the system's accuracy in ranking query results of subsequently executed queries. User feedback is easily obtained and can serve as inexpensive and accurate labels for feature vectors of query results used for training a machine learning model to rank query results. A machine learning model can be trained specific to each query and the model can be trained by any appropriate supervised learning technique.

The system can extract features for each query result from an approximation of a query derivation graph representing the intermediate processing states and processing steps of an executed query. In other words, the system can extract features for each query result without computing an entire query derivation graph for a query, which is computationally costly and time-consuming.

Query writers can experiment with different techniques and heuristics that would otherwise not be used for fear of returning false positives or omitting relevant query results. A heuristic can be an approximation that works well in most cases, but fails or gives poor results in a minority of cases. For example, if the database represents source code, and the query performs static code analysis, then heuristics may make assumptions about likely execution paths, or likely variable bounds for the source code. The system allows query writers to more aggressively experiment with heuristics because users can indirectly fine-tune the query's heuristics through user feedback.

Further, users can obtain relevant results even if their preferences are not known when the query was generated, or because their preferences are not directly expressed in the database.

The subject matter described in this specification can be implemented regardless of the programming language of a query and the data stored in a database, and can also be implemented regardless of the type of analysis performed by the query. The system can rank query results for a query even when the query is executed on databases storing different but similar types of data, e.g., databases of financial information, health records, or personnel records. Feedback from users of one database storing financial records, for example, can be used to train a model to rank query results obtained from executing a query on another database, also storing financial records.

If a database system stores a code base, queries executed to identify coding defects can be ranked to identify the most important defects. Developers of the code base can use the query results to then address issues in order of importance, e.g., serious software defects or security vulnerabilities. Developer resources can be directed first to more important issues in the code base to facilitate the maintenance—and therefore the stability—of the code base.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example database system interacting with a user device.

FIG. 2 illustrates how the database system generates ranked query results, in one embodiment.

FIG. 3 illustrates an example approximate query derivation graph.

FIG. 4 illustrates an example result graph for a query result.

FIG. 5 is a flow chart of an example process for generating ranked query results.

Like reference numbers and designations in the various drawings indicate like elements.

### DETAILED DESCRIPTION

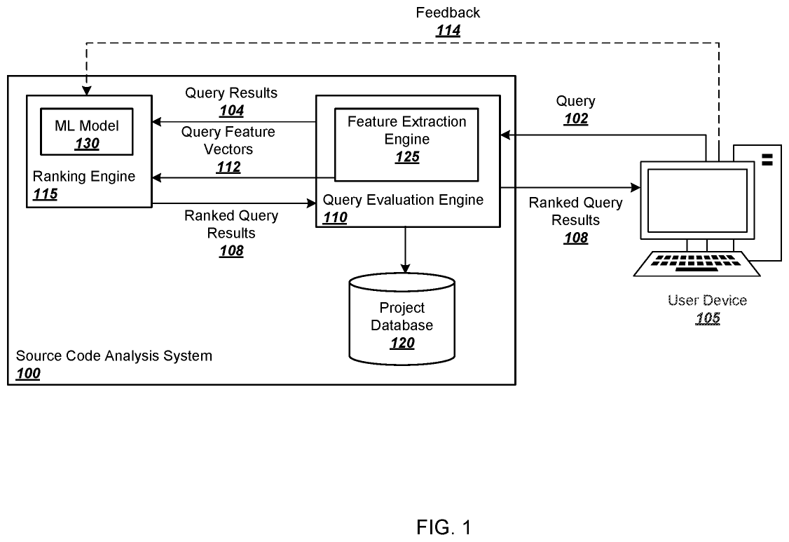

FIG. 1 illustrates an example database system 100 interacting with a user device 105. The user device 105 can be any computer appropriately configured to communicate with the system 100, e.g., a laptop, smartphone, or tablet. The user device 105 can communicate with the system 100 over any appropriate network, e.g., a local intranet or the Internet, or a combination of both. The user device 105 can be directly connected to the system 100, e.g., by cables, or the database system 100 can be installed in whole or in part on the user device 105. The user device 105 can be configured to send a query 102 to the system 100, and receive ranked query results 108 from the system 100. Although only one user device is shown in FIG. 1, in some implementations, the system 100 can communicate with multiple user devices.

The database system 100 includes a query evaluation engine 110, a ranking engine 115, and a database 120. Each component of the database system 100 can be installed on the same computer, or on separate computers that are communicatively coupled as appropriate, e.g., by physical connection or over a network.

The database 120 can be any type of database that can be appropriately queried as described in this specification. In some implementations, the database is a relational database. The database can store, for example, personnel records for employees at an enterprise, health care records for patients of a health-care system, or financial records. The techniques described in this specification to rank query results do not depend on the nature of the data stored in the database. The database system 100 can receive any appropriately written query to query a database storing any kind of information and rank query results by user relevance without departing from the description provided in this specification. Although FIG. 1 shows one database 120, in some implementations the database system 100 can maintain a plurality of databases.

Alternatively, the database 120 can be a database storing projects as described above, i.e., by storing tuples representing source code elements of one or more projects. In some implementations, the database 120 can store source code elements for multiple projects, and the database system 100 can include functionality for receiving queries as queries to the database 120 and returning one or more query results for each query.

The query evaluation engine 110 can be configured to receive a query 102 from a user device. The query 102 can be sent as one or more predicates that a user of the user device 105 can specify, for example by interacting with the database system 100 through an interface installed on the user device 105. The user can select which database they would like to query, and can combine and customize queries to be sent to the query evaluation engine 110. In some implementations, the user through the user device 105 can create custom queries and save those custom queries to the user device 105 to be re-sent to the database system 100 at a later date. Users can send the queries periodically, e.g., weekly, to track the progression of a project stored in the database 120. Users may also send the same query for the system 100 to execute on different projects stored in the database 120.

The query evaluation engine 110 can receive the query 102. In some implementations, the database system 100 is configured to store queries written by query writers. Query writers may be project developers for a project stored in the database, or query writers may be other users maintaining and offering the database system 100 for use by others to store data.

The query evaluation engine 110 can execute the query 102 on the database 120. In response, the query evaluation engine can generate query results 104 for the executed query 102. The number of results returned in the query results 104 depends on the data that was queried and the query that was executed. In some implementations, the database 120 stores source code for multiple different projects. In these implementations, the query 102 may return zero results for one project, 10 results for another project, and 1000 results for yet another project in the database 120.

The query results 104 are in an initial ordering. An initial ordering for the query results 104 can be that the individual results are in no particular order when presented to a user, e.g., on a display of the user device 105. This can mean, for example, that false positives can appear at the top of a list of the query results 104 to the user, and individual results that are more important to the user can be buried in the list of potentially thousands of results.

Therefore, when the query evaluation engine 110 generates the query results 104, the engine 110 can send the query results 104 to the ranking engine 115. The ranking engine 115 can be configured to receive, as input, a list of query results 104, and return, as output, a list of ranked query results 108. The ranked query results 108 can be sent to the user device 105 that sent the query 102. The ranked query results 108 can be ranked according to a machine learning model 130 that the ranking engine 115 implements.

The machine learning model 130 can be configured to operate in an update mode and an apply mode. In the apply mode, the machine learning model 130 can receive, as input, feature vectors corresponding to each query result in the query results 104, and output labels denoting the predicted relevance of each query result, as the ranked query results 108.

In the update mode and as discussed below, the ranking engine 115 can train the machine learning model 130 to determine trained values of parameters of the machine learning model 130, from initial values of the parameters. As the ranking engine 115 generates additional training data from user feedback and query feature vectors 112, the ranking engine 115 can use the additional training data to update the machine learning model 130.

The machine learning model 130 can predict ranks for the ranked query results 108 as numeric scores, e.g., the machine learning model 130 can output, for N query results, scores for each query result from 1 (most important) to N (least important). In some implementations, the machine learning model 130 can predict ranks for the query results categorically. For example, query results can be labeled “relevant” or “not relevant.” Alternatively, query results can be ranked by degrees of importance, e.g., “highly important,” “moderately important,” or “not very important.” In general, the machine learning model 130 can be configured to predict rankings for query results in any manner consistent with how users can provide feedback of query results.

The database 120 can store one or more relations as tuples representing source code elements of a code base of a software project. A source code element can be source code representing a discrete part of the project, e.g., a class, method, or field, and each tuple can store features of a respective source code element, e.g., a class name, a list of class dependencies, or locations of other tuples representing related source code elements. For example, a tuple may represent a source code element that is a particular method of a class in the project, and the tuple may store the locations of other tuples in the database representing other methods in the same class as the particular method.

Queries can be written to perform source code analysis on a project and return query results based on the performed analysis. A query can include predicates or rules for what sorts of source code elements should be returned by executing the query. Queries can include a number of functions that are configured to execute discrete portions of the query, e.g., reading from the database 120 or evaluating a predicate. Queries can be written in any programming language that can be used to query a database and that can written as one or more predicates, e.g., Datalog, Prolog, SQL, or .QL. Queries can also be written in procedural languages, e.g., Python.

For example, a query can include predicates that when satisfied by a source code element in a project, indicate that the source code element violates a coding standard, e.g., the source code element has a mismatch of variable types.

A query result for this example query can be an alert representing where in the project the violation occurred, as well as the type of violation that occurred, In some implementations, multiple queries are executed together to obtain query results representing multiple types of defects, where each query in the multiple queries is written to catch one respective type of defect. An executed query can cause a database system to return as little as zero query results, or return millions of query results, depending on the project.

Other source code analysis techniques that can be performed by a query include analyzing and returning source code elements based on characteristics of the source code, e.g., source code elements having a certain number of lines, as well as analyzing a project and returning the identities of developers responsible for different contributed source code elements.

Users can score or label query results based on how relevant they think a query result is. For example, some query results may be alerts for discovered software defects in a project stored in the database 120. Some discovered software defects may be more serious than others, therefore users can score or label query results for the more serious software defects higher than the alerts for the less serious software defects. Because it can be difficult or even impossible to generate queries that encode a user's preferences at the time the query is generated, the ranking engine 115 can receive valuable information from user feedback to update the parameters of the machine learning model 130 to predict which query results are more relevant to users than others.

The ranking engine 115 can use user feedback from different, unrelated projects to label query feature vectors by relevance. For example, the database 120 can store many different projects, e.g., 1000 different projects, with each project developed by a different team of developers. While each project may be different, the projects may still share some similarities, e.g., because different projects may be written in the same programming language. If a user provides feedback for query results of alerts for source code violations in one project, it is likely that the feedback is relevant for one or more other projects in the database 120. Therefore, the ranking engine 115 has access to a large and rich resource of training labels to update the machine learning model for each query sent to the database system 100, especially as the same query may be executed on different projects with the corresponding query results reviewed by many different users.

Ranked query results help mitigate time wasted by users on query results that are of low or no relevance to the users, including query results that are false positives. In some implementations where the database 120 stores many different source code projects, low relevance or irrelevant results in query results are a hindrance for developers. These results can be technically responsive to the predicates of the query 102 that a query writer wrote, but nonetheless not be relevant to the user.

Low relevance or irrelevant results can occur because the query writer is often unaware of a user's preferences when writing a query that the user later executes. Alternatively, even if the query writer does know a user's preferences for query results, he or she may be unable to encode these preferences even in a very intricately written query. For example, the user's preferences may have complex conditional or statistical properties that are difficult to express as a sequence of predicates in a query. For similar reasons, the query results 104 can omit results that are actually relevant to a user.

The ranking engine 115 can be configured to order the query results 104 according to the predicted ranks generated by the machine learning model 130, to generate the ranked query results 108. Because some query results may not be very relevant or not relevant at all to users, the ranked query results 108 will have these query results ranked very low. In practice, users can focus on relevant query results that can be presented higher in a list of results over less relevant or irrelevant results.

Alternatively, the ranking engine 115 can be configured to omit query results ranked below a ranking threshold, e.g., the ranking engine 115 can omit results labeled “not very important,” or results labeled in the bottom 15 percent of all query results. The ranking engine 115 can be configured with the ranking threshold, or the ranking engine 115 can be configured to receive a ranking threshold as a parameter for the query 102 from the user device 105.

The machine learning model 130 can be specific to the query 102, meaning that the machine learning model 130 is trained to rank query results generated from the query 102. Because the database systems can receive many different queries, the ranking engine 115 can be configured to maintain multiple machine learning models, with each model corresponding to a different query.

If the ranking engine 115 receives query results for a new query that has not been previously executed by the database system 100, the ranking engine 115 can be configured to generate and train a new machine learning model for the new query. A description of how the ranking engine 115 generates and trains a new machine learning model follows, below.

A machine learning model for a query can be implemented and trained by any appropriate supervised learning technique, e.g., implemented as a neural network, a support vector machine, a regression model, e.g., linear or logistic regression, a random forest model, gradient boosted trees, naive Bayes, nearest neighbors, decision trees, or as Gaussian process. Training data for the machine learning model can be labeled feature vectors of query results generated by the query evaluation engine 110 executing a query. The features for the machine learning model 130 can include any informational aspect of a query, e.g., the precise details of the query's run-time execution including the query's use of complex query libraries, and database relations, including, input, output and intermediate relations. As discussed in more detail, below, the feature extraction engine 125 can extract features for each query result based on a query derivation graph of the query, and the ranking engine 115 can label extracted feature vectors for each query result from user feedback.

When the query evaluation engine 110 executes the query 106, the query evaluation engine 110 can perform a number of processing steps before generating the query results 104. The processing steps can include executing functions in the query 102 for individual predicates that the query evaluation engine 110 executed to obtain a final query result responsive to the query 106.

As an example, consider a query to search the database 120 having the predicates X, Y, and Z joined by conjunctions: X AND Y AND Z. The query evaluation engine 110 can generate a corresponding query that includes the predicate X AND Y AND Z. For the purposes of this example, when the query evaluation engine 110 executes the query 102, the query returns a final query result having characteristics satisfying the predicate X AND Y AND Z. The individual predicates X, Y, and Z are processing steps that the query evaluation engine 110 has to execute as part of the query 102 before arriving at a final query result.

Processing steps can also include executing functions in the query for reading locations of tuples from the database 120, which in turn may be fed as input for other functions in the query 102 to read locations and features of other tuples stored in the database 120. In some implementations, the processing steps can also include executing functions for compiling and executing, by the database system 100, portions of source code of a code base stored in the database 120, and producing intermediate output from the executed source code.

The query evaluation engine 110 executes a sequence of processing steps, and constructs a corresponding sequence of intermediate results, until obtaining a final query result. In this specification, the sequence of processing steps and intermediate results is referred to as the data-flow path of the final query result.

The query evaluation engine 110 can add the final query result to the query results 104. The query evaluation engine 110 can repeat this process to add additional query results to the query results 104. In some implementations, the query evaluation engine 110 can add an alert describing the location of the source code element in the project to the query results 104, as well as information regarding a type of violation the final source code element triggers. In some implementations, the query result is a source code element for a project stored in the database 120.

The query evaluation engine 110 can generate a query log representing partial or complete data-flow paths for each query result of the query results 104. The query evaluation engine 110 includes the feature extraction engine 125. The feature extraction engine 125 can be configured to generate a query derivation graph from the query log.

A query derivation graph represents the partial or complete data-flow path for each query result in a set of query results. Each node in the query derivation graph represents a processing state for the query. A processing state can represent a parameters or a subset of parameters to a processing step, or a result or a subset of results returned by executing a processing step in the query 106, which in turn can serve as parameters for another processing step. A processing state can also represent the values or a subset of values for a final query result in the query results 104. For example, a processing state can represent a subset of an intermediate or final tuple, e.g., a row of a table, obtained by executing the query. If a query result is an n-tuple of unique values, then the query derivation graph can represent the query result as n different nodes.

Each edge in the query derivation graph is a processing step. Node A is connected by edge E to node B if the processing state B is produced as output by processing step E executed with inputs that include A.

For large, complex databases, the computational time and space costs to generate a query derivation graph is prohibitive. In some implementations, the feature extraction engine 125 can generate an approximation of the query derivation graph for a query, instead of the full query derivation graph. Discussion of how the feature extraction engine 125 generates an approximated query derivation graph and extracts features for each query result is discussed below.

The feature extraction engine 125 can obtain the query results 104 generated by the query evaluation engine 110. The feature extraction engine 125 can be configured to extract, for each query result in the query results 104 and from a query derivation graph or approximated query derivation graph, a corresponding feature vector of features for the query result. The feature extraction engine 125 can then send query feature vectors 112 to the ranking engine 115.

The ranking engine 115 can be configured to label the query feature vectors 112 by relevance to users of the database system 100. The database system 100 can prompt the user of the user device 105 to provide feedback about the relevance of query results sent to the user device 105 in response to the query 102.

For example, the database system 100 can send the ranked query results 108 to the user device 105, and the user of the user device 105 can provide feedback on the ranked query results 108. In some implementations, the user device 105 is configured to display the ranked query results with an interface for the user to rate each result as “relevant” or “not relevant” to a query. The interface can include selectable icons for the user to rate each result, e.g., with a thumbs up icon or a thumbs down icon. In some implementations, if many query results are returned for a query, the user device 105 can prompt the user to rate only a sample of results. The database system 100 can select which results are sampled so as to obtain as much ranking information as possible from a relatively small amount of user feedback.

The database system 100 can implicitly collect feedback from users without prompting the users for feedback. The database system 100 can obtain other information about user behavior, such as the rate in which, for example, developers address coding defects identified in query results. If a particular type of coding defect is addressed faster and more often than other types of defects, then the database system 100 can treat this information as implicit feedback that the particular type of defect is more relevant to users than other types of defects.

The user device 105 can submit queries that the ranking engine 115 will have already generated and trained for a corresponding machine learning model. In some implementations, when the database system 100 sends the ranked query results 108 to the user device 105, the user device 105 prompts the user to provide feedback 114 of the ranked query results 108. The ranking engine 115 can receive and use the feedback 114 to label the corresponding feature vectors in the query feature vectors 112 for each query result.

Once the ranking engine 115 labels the query feature vectors 112 with the feedback 114, the ranking engine 115 can use the labeled query feature vectors to train the machine learning model 130. The labeled query feature vectors can be batched or each labeled query feature vector can be used to individually retrain the machine learning model 130. The ranking engine 115 can train the machine learning model 130 using any appropriate supervised learning technique, e.g., by reducing a prediction error on the training data with first-order optimization methods, such as gradient descent, or by second-order optimization methods, e.g., Newton's method. Other techniques for training the machine model 130 include linear or quadratic programming methods, satisfiability (SAT) solvers, e.g., by SAT solver modulo theories, Markov Chain Monte Carlo methods, or by evolutionary algorithms.

The ranking engine 115 can train the machine learning model 130 until meeting a predetermined condition. In some implementations, the ranking engine 115 stops training the machine learning model 130 after iterating training steps for the machine learning model 130 a predetermined number of times. In some implementations, the ranking engine 115 stops training the machine learning model 130 when differences between iterations of computed loss values fall below a predetermined threshold.

If the user device 105 sends the system 100 a new query as described above, then the ranking engine 115 can use any appropriate supervised learning training technique to generate and train a new machine learning model using the labeled query feature vectors. In those implementations, the ranking engine 115 can initialize the weights of the new machine learning model randomly, or based on some other appropriate technique for initializing a machine learning model.

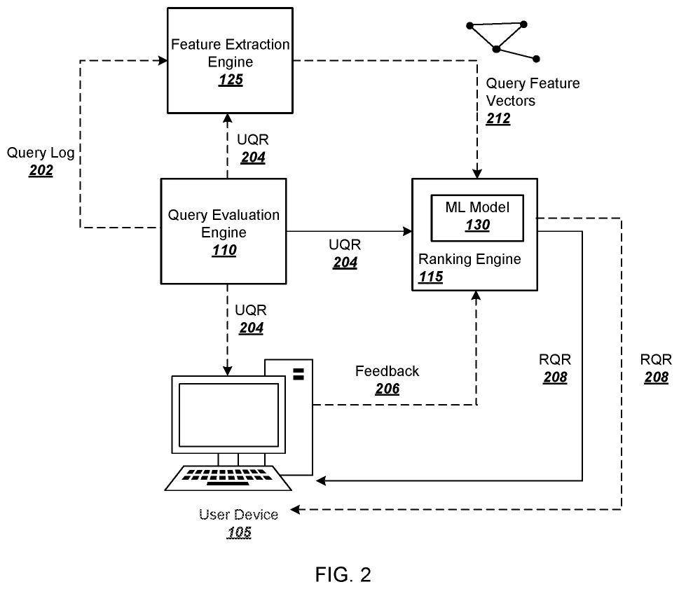

FIG. 2 illustrates how the database system 100 generates ranked query results, in one embodiment. As discussed above, the query evaluation engine 110 can execute a query 201 to generate unranked query results 204. As indicated by the solid and dotted lines in FIG. 2, the database system 100 can process the unranked query results 204 in two different ways.

The solid lines represent how the system 100 can generate the ranked query results 208 without requesting user feedback. The dotted lines represent how the system 100 can solicit feedback from the user of the user device 105 and generate labeled query feature vectors that can be used to update the machine learning model 130.

The system 100 can be configured to generate ranked query results 208 and solicit feedback from the user every time the system 100 executes query 201. In some implementations, the system 100 may not prompt for user feedback to update the machine learning model 130 every time the system 100 executes a query, e.g., because the system 100 is configured to only prompt the user for feedback periodically. Alternatively, the user can decide when to provide feedback, and the system 100 can be configured to prompt for feedback only at the user's request.

Following the solid lines of FIG. 2, the unranked query results 204 can be provided as input to the ranking engine 115, which has the machine learning model 130 trained to rank input query results generated from the query evaluation engine 110 executing the query 106. The ranking engine 115 can then generate the ranked query results 208, and send the ranked query results 208 to the user device 105.

Following the dotted lines of FIG. 2, unranked query results 204 can be sent to the feature extraction engine 125 and the user device 105. As described above with reference to FIG. 1, the user device 105 can prompt the user to provide feedback 206 of the unranked query results 204 to the ranking engine 115.

The feature extraction engine 125 can receive the unranked query results 204 and generate query feature vectors 212. To generate the query feature vectors 212, the feature extraction engine 125 can first obtain query log 202 from the query evaluation engine 110. The query log 202 represents the data-flow paths for each query result in the unranked query results 204.

The feature extraction engine 125 can generate a query derivation graph or an approximation of a query derivation graph from the query log 202. The feature extraction engine 125 can generate an approximation of the query derivation graph, which is more efficient when generating a query derivation graph would otherwise be prohibitively complex and computationally expensive.

The feature extraction engine 125 can generate an approximate query derivation graph by selectively omitting sub-graphs according to logical filtering criteria. For example, the feature extraction engine 125 can filter an approximate derivation graph by omitting all input and output tuples generated by one or more predicates. In addition or alternatively, the feature extraction engine 125 can omit all tuple values of a specific type or set of types defined by the query programming language. Such logical filters can be created to include only those parts of the derivation graph that are predictive of users' preferences. The filters also control the trade-off between the computational cost of generating the approximate query derivation graph and extracting features from the graph to train the machine learning model 130 to make more accurate predictions. For example, more stringent filters will reduce the computational cost of generating the approximate query derivation graph, but at the potential cost of less training data extracted from the graph. In addition to logical filtering, some approximate query derivation graphs correspond to precisely the information that is generated during the normal execution of the query program.

The feature extraction engine 125 can generate the approximate query derivation graph by first generating a node for each processing state of the query as it was executed by the query evaluation engine 110.

Then, the feature extraction engine 125 can connect nodes that appear together in the same processing state, e.g., an n-tuple of unique values can be represented by n separate nodes connected as an undirected graph. The feature extraction engine 125 can label edges that connect pairs of nodes with the name of the processing step that generated a processing state represented by a respective node in a pair of nodes. For example, if sub-function, sub-query or predicate named “# select # ff # join_rhs” generated an n-tuple, then the n separate nodes can be connected by edges labeled “# select # ff # join_rhs”.

The feature extraction engine 125 can connect nodes that represent the final query result for the query, to other nodes that represent previous processing states for the query, as well as that original values that appear in a queried database. In effect, the approximated query derivation graph can dispense with computationally intractable intermediate input-output tracking (e.g., input processing state A caused the generation of output processing state B due to processing step X) and instead use output-output tracking (e.g. processing state A was generated as output by processing steps X, Y and Z).

Generating the approximate query derivation graph adds negligible computational cost to executing the query, because all of the processing states and steps represented by the query derivation graph are obtained as part of executing the query. For example, if the query was written in a programming language having a bottom-up execution, e.g., Datalog, then the approximate query derivation graph can be generated as part of the normal operation of bottom-up Datalog execution.

The approximate query derivation graph connects nodes representing processing states and edges representing processing steps to nodes representing query results. A query result, represented as a unique subset of nodes in the graph, connects to other nodes in unique ways. Therefore, the query derivation can approximately capture the “reasons” why specific query results are generated through subgraphs defined by unique nodes and edges of the query derivation graph. The feature extraction engine 125 can extract and represent these reasons as inputs to a machine learning model that can be trained to predict the relevance of a query result to a user.

The feature extraction engine 125 can generate, for each query result in the unranked query results 204, a subgraph of the query derivation graph or approximated query derivation graph. In this specification a subgraph of the query derivation graph or approximated query derivation graph is referred to as a result graph. The feature extraction engine 125 can generate the result graph for a query result to include all nodes and edges within a predetermined degree of separation from the node or nodes representing the query result. For example, the feature extraction engine 125 can be configured to generate result graphs that include nodes that are one degree of separation away from the node representing the query result.

From the result graph the feature extraction engine 125 can extract features for a query feature vector for the query result. Features extracted from the result graph can be any appropriate graph metric for the result graph. For example, graph metrics can be for nodes of the result graph, edges of the result graph, or relationships between nodes and edges in the result graph.

Graph metrics for nodes of the result graph can include: the number of nodes in the result graph, values of processing states represented by other nodes in the result graph, degree centrality for each node, e.g., an edge in-degree and edge out-degree for each node, a distribution or mean of all node degrees, node connectivity, e.g., the smallest number of nodes that, if deleted, would produce a disconnected result graph. Graph metrics for nodes can also include any appropriate measure of centrality for each node, e.g., the closeness centrality, the betweenness centrality, the eigenvector centrality, the Katz centrality, the Page Rank centrality, the HITS centrality, the integration or radiality centrality, the status centrality, and the edge betweenness centrality.

Graph metrics for edges in the result graph can include: the number of edges in the result graph, the number of edges appearing that represent a particular processing step, and the number of edges representing different predicates, edge connectivity, e.g., the smallest number of edges that, if deleted, would produce a disconnected result graph.

Graph metrics for relationships between nodes and edges can include: a mean edge distance, a mean clustering coefficient, a statistical distribution or mean of shortest path distances between nodes, graph eccentricities, e.g., the diameter and radius of the graph, lengths of the longest shortest paths from one node to another node, the Salton similarity of the graph, the reciprocity of the graph, the Pearson correlation coefficients, an average neighbor degree for each neighbor of a node, the dice similarity coefficient, and the Jaccard similarity coefficient.

The feature extraction engine 125 can map extracted features from a result graph to a fixed-length vector representation. In some implementations, the feature extraction engine 125 can apply any appropriate graph embedding technique to represent a result graph as a fixed-length vector. For example, the feature extraction engine 125 can apply graph embedding techniques processing the result graph through a neural network having multiple convolutional layers to reduce the result graph to a fixed-length embedding vector.

The feature extraction engine 125 can generate the query feature vector for each query result and send the query feature vectors to the ranking engine 115. The ranking engine 115 can then associate each query feature vector with a corresponding score or label for the respective query result, to generate a labeled query feature vector. The labeled query feature vector can then be supplied as training data to update the weights of the machine learning model for the respective query, as discussed above with reference to FIG. 1.

Referring again to FIG. 2, whether or not the user sent feedback through the user device 105, the ranking engine 115 can return ranked query results 208 to the user device 105. The user, upon receiving the ranked query results 208 can provide additional feedback to the ranking engine 115.

An example follows for how a feature extraction engine can generate query feature vectors for query results. Consider query 1 with the following predicates as in the query shown in TABLE 2, above, and reproduced below:

TABLE 2

| | |
|---|---|
| 1 | from Person person |
| 2 | Where person.getLocation( ) = “south” and person.getAge( ) < 40 |
| 3 | Select person, person.getName( ) |

In this example, assume that the database queried is a database storing people's names, ages, and locations, as shown above in TABLE 1 and reproduced below:

TABLE 1

| Person | ID | Age | Location |
|---|---|---|---|
| Aaron | 6000 | 49 | south |
| Abby | 3000 | 24 | east |
| Abdul | 4300 | 37 | west |
| . . . | . . . | . . . | . . . |
| . . . | . . . | . . . | . . . |
| Milton | 9000 | 75 | south |

TABLE 1 shows that each person is associated with four different fields that can collectively be represented as a tuple defined as: {Person, ID, Age, Location}. For example, the first person in the database is Aaron, and Aaron is represented by the tuple: {“Aaron”, 6000, 49, “south”}. Referring back to the query as shown in TABLE 2, the query, when executed, returns the names of people located in the south who are less than 40 years old.

A query evaluation engine as described in this specification can execute the query to generate query results from a database. For example, the database system can generate query results for query 1 as executed on the database shown in TABLE 2. For example, the query results for query 1 can include the eleven example results shown in TABLE 3, above, and reproduced below:

TABLE 3

| Person | ID |
|---|---|
| Almira | 1800 |
| Bruce | 400 |
| Charlie | 1500 |
| George | 1500 |
| Ira | 6600 |
| Laura | 1400 |
| Maya | 1100 |
| Milton | 7800 |
| Nala | 9400 |
| Simba | 9300 |
| Sylvester | 8600 |

Depending on the size of the database, executing query 1 on the database can return many, many results. A user who sends query 1 to the query evaluation engine may also have a preference of some query results over others. For example, a user who sends query 1 to the query evaluation engine may be interested in people having fashionable names. This preference may not have been known at the time query 1 was written. Further, the concept of a “fashionable name” is not directly expressed in the database, e.g., looking at the database alone there is no way to tell if “Simba” or “Milton” are fashionable names and therefore preferable to the user over other names, such as “Ira” or “Sylvester.”

Therefore, after the query evaluation engine generates the query results as shown in TABLE 3, the user can supply feedback by scoring the relevance of each result of a subset of query results. This scoring implicitly defines what the user considers relevant, which in this case is whether a name of a person is fashionable or not. TABLE 4 shows an example of how the user may rank the query results of TABLE 3:

TABLE 4

| Person | ID | Rank |
|---|---|---|
| Almira | 1800 | 1 |
| Bruce | 400 | 10 |
| Charlie | 1500 | 9 |
| George | 1500 | 4 |
| Ira | 6600 | 2 |
| Laura | 1400 | 3 |
| Maya | 1100 | 8 |
| Milton | 9000 | 11 |
| Nala | 9400 | 5 |
| Simba | 9300 | 6 |
| Sylvester | 8600 | 7 |

The rank corresponds to the user's preference for the name of each person in the database. In TABLE 4, “Almira” is ranked 1 of 11 meaning the user found the name to be the most fashionable, while “Milton” was ranked 11 of 11, meaning the user found the name to be the least fashionable.

The query evaluation engine can generate a query log representing the data flow path for each query result in TABLE 3. From the query log, the feature extraction engine can generate the query derivation graph or an approximated query derivation graph for query 1.

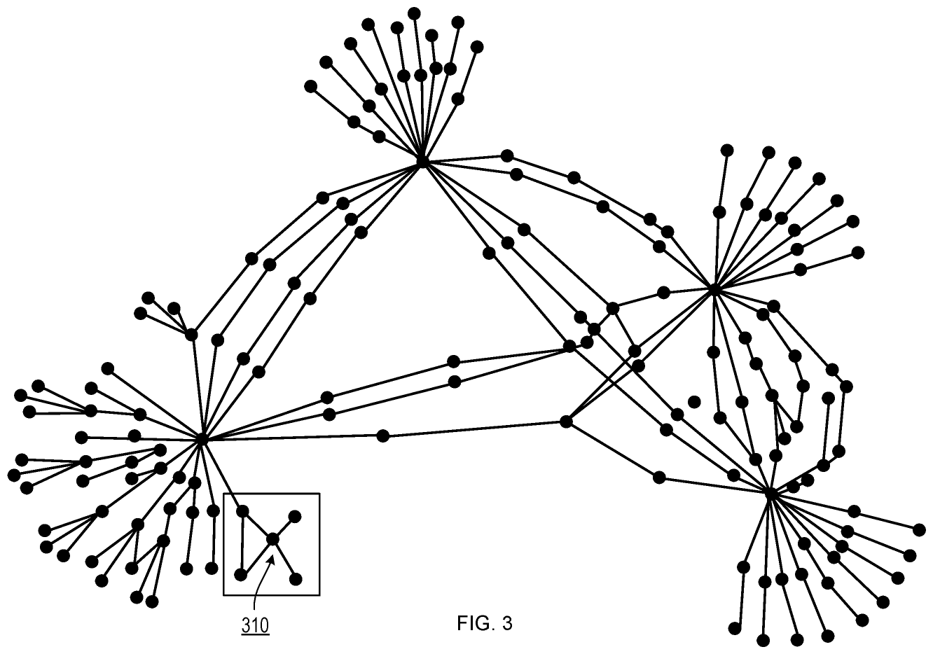

FIG. 3 illustrates an example approximate query derivation graph. Specifically, FIG. 3 shows an example query derivation graph after the database system executes query 1 on the database as shown in TABLE 1. Node 310 represents a final query result in shown in TABLE 4 for “Almira.” Other nodes in the query derivation graph illustrated in FIG. 3 can represent other query results generated by executing query 1, as well as intermediate processing states and steps. From a neighborhood of nodes 320 proximate to the node 310 on the example query derivation graph, the system can generate a result graph for the query results “Almira.”

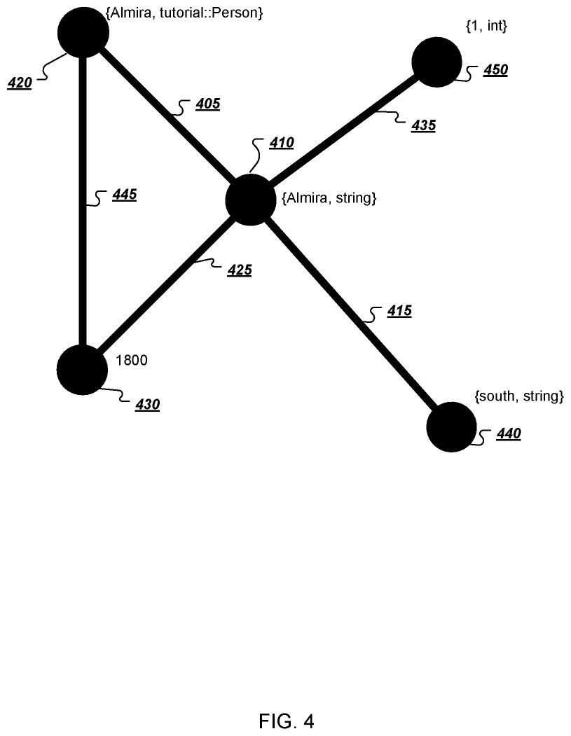

FIG. 4 illustrates an example result graph for a query result. Specifically, FIG. 4 shows the query result for “Almira” as represented by the node 310 in FIG. 3. Nodes 420-450 represent values associated with the query result string “Almira” in the database. The nodes 420-450 also appear in the neighborhood of nodes 320 shown in FIG. 3. Node 420 represents the object type (“Person”), node 430 represents the person ID (“1800”), node 440 represents the location string of the Person (“south”), and node 450 represents the age of the person (“1”).

The example result graph also has edges 405-445, which can represent different processing steps, as described above. For instance, an edge can represent one or more predicates for selecting a tuple in the database, querying the database, and joining different predicates together.

From the result graph illustrated in FIG. 4, the feature extraction engine can generate the following features for “Almira” shown in TABLE 5:

TABLE 5

| #select#ff | #select#query#fff | #select#ff#join_rhs | Nodes | Age | Location | ID |
|---|---|---|---|---|---|---|
| 1 | 3 | 2 | 5 | 1 | south | 1800 |

The first three features shown in TABLE 5 represent the number of times each predicate of the three predicates in the result graph of FIG. 4 appeared. The “nodes” feature represents how many nodes appeared in the result graph. The feature extraction engine can use some or all of the features extracted from the result graph to generate the query feature vector for the query result. In some implementations, the feature extraction engine is configured to vary what features are used to generate the query feature vectors, to find stronger associations between individual features and the labeled ranking for the query result that may not otherwise have been discovered. For example, the feature extraction engine can generate the query feature vectors by representing the result graph as a graph embedding, by processing the result graph through a neural network having convolution layers, as discussed above.

For example, from training a machine learning model on labeled query feature vectors as described in this example, the machine learning model might learn that the age of a person is a weakly predictive feature for the user's concept of a “fashionable name.” Younger people tend to have more fashionable names, therefore the machine learning model may learn to associate a younger age with a higher rank.

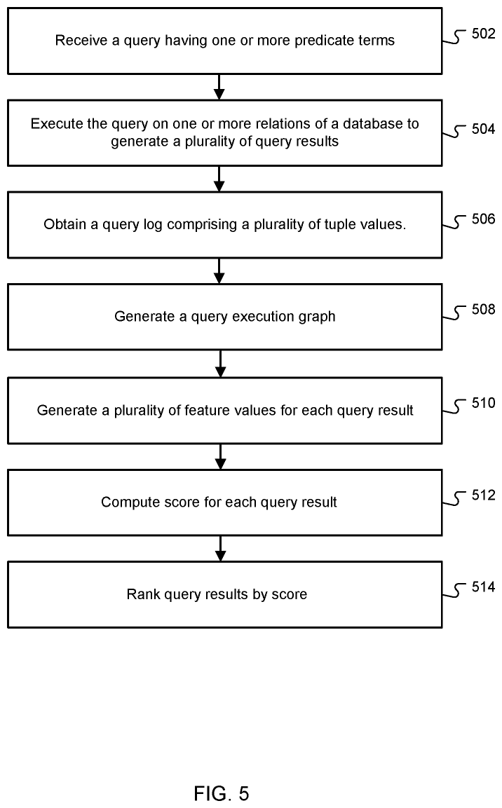

FIG. 5 is a flow chart of an example process for generating ranked query results. For convenience, the example process will be described as being performed by a system of one or more computers, located in one or more locations, and programmed appropriately in accordance with this specification. For example, a database system, e.g., the database system 100 of FIG. 1, appropriately programmed, can perform the example process of FIG. 5.

The system receives a query having one or more predicate terms (502).

The system executes the query on one or more relations of a database to generate a plurality of query results (504).

The system generates a query derivation graph (506). As discussed above with reference to FIG. 1, the query derivation graph can have nodes that each represent a distinct tuple value of the plurality of tuple values in the query log and have edges between pairs of nodes. Each edge between a respective pair of nodes in the query derivation graph represents a predicate term of the one or more predicate terms of the query that is related to tuple values corresponding to the respective pair of nodes connected by the edge.

The system generates a plurality of feature values for each query result of the plurality of query results (508). As described above with respect to FIG. 3, the system can extract features from result graphs corresponding to each query result and some or all of the features to generate a query feature vector the query result.

The system computes a score for each query result of the plurality of query results by using the plurality of feature values generated for the query result as input to a trained ranking model (510). The score predicts the relevance the query result has based on labeled query feature vectors that the system used to train a machine learning model to rank query results for a query.

The system ranks the plurality of query results according to computed scores generated by the trained ranking model (512). The system can then present the ranked query results to the user through a user device. The user can then provide additional feedback based on the relevance of each query result as ranked by the system.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

In this specification, the term “database” will be used broadly to refer to any collection of data that can be queried with an appropriate query language: the data does not need to be structured in any particular way, or structured at all, and the data can be stored on storage devices in one or more locations. Thus, for example, a database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method comprising: receiving a query having a plurality of predicates; executing the query on one or more relations of one or more databases to generate a plurality of query results, comprising executing the plurality of predicates to generate a plurality of tuple values; generating a query derivation graph for the query, wherein the query derivation graph comprises: nodes that each represent one or more distinct tuple values of the plurality of tuple values, and edges between pairs of nodes, wherein each edge between a respective pair of nodes represents one or more predicates of the plurality of predicates of the query that generated tuple values corresponding to the respective pair of nodes connected by the edge, during the execution of the query; generating, from the query derivation graph, a plurality of feature values for each query result of the plurality of query results; computing a score for each query result of the plurality of query results by using the plurality of feature values generated for the query result as input to a trained ranking model; and ranking the plurality of query results according to computed scores generated by the trained ranking model.

Embodiment 2 is the method of embodiment 1, wherein: wherein generating, from the query derivation graph, the plurality of feature values for each query result of the plurality of query results comprises: computing one or more properties of a query derivation subgraph for a particular query result in the plurality of query results.

Embodiment 3 is the method of any one of embodiments 1 through 2, wherein the one or more properties of the query derivation subgraph comprise graph metrics, wherein the graph metrics comprise one or more metrics for the nodes of the query derivation graph, the edges of the query derivation graph, or for relationships between the edges and the nodes of the query derivation graph.

Embodiment 4 is the method of any one of embodiments 1 through 3, wherein the one or more properties of the query derivation subgraph comprise a graph metric representing a number of times a particular predicate type was executed while executing the query to generate the particular query result.

Embodiment 5 is the method of any one of embodiments 1 through 4, wherein the one or more properties of the query derivation subgraph comprise a graph metric representing a number of nodes in the query derivation subgraph.

Embodiment 6 is the method of any one of embodiments 1 through 5, wherein generating, from the query derivation graph, the plurality of feature values for each query result of the plurality of query results comprises: generating a graph embedding of the query derivation subgraph for the particular query result, wherein the graph embedding represents the one or more properties of the query derivation subgraph.

Embodiment 7 is the method of any one of embodiments 1 through 6, wherein the one or more properties of the query derivation subgraph comprise a graph metric representing a number of edges in the query derivation subgraph.

Embodiment 8 is the method of any one of embodiments 1 through 7, further comprising training the trained ranking model on labeled data obtained by: executing the query on the one or more relations of the one or more databases to generate the plurality of query results, and obtaining the labeled data as user feedback for each query result of the plurality of query results.

Embodiment 9 is the method of any one of embodiments 1 through 8, further comprising: after executing the query on the one or more relations of the one or more databases to generate the plurality of query results: obtaining the user feedback for each query result of the plurality of query results, and updating weights of the trained ranking model using the user feedback.

Embodiment 10 is the method of any one of embodiments 1 through 9, further comprising: after executing the query on the one or more relations of the one or more databases to generate the plurality of query results: executing the query again on the one or more relations of the one or more databases to generate a plurality of second query results, obtaining second user feedback for each second query result of the plurality of second query results, and updating the weights of the trained ranking model using the second user feedback.

Embodiment 11 is the method of any one of embodiments 1 through 10, further comprising: receiving a plurality of queries; for each query in the plurality of queries, executing the query on the one or more relations of the one or more databases to generate a respective plurality of query results; and for each query in the plurality of queries, computing a score for each query result of the respective plurality of query results for the query by using a respective plurality of feature values generated for the query result as input to a respective trained ranking model for the query.

Embodiment 12 is the method of any one of embodiments 1 through 11, wherein the trained ranking model is trained to generate scores for query results obtained from executing the query.

Embodiment 13 is the method of any one of embodiments 1 through 12, wherein computing a score for each query result of the plurality of query results by using the plurality of feature values generated for the query result as input to a trained ranking model comprises: computing the score for each query result by a predicated relevance of each query result.

Embodiment 14 is the method of any one of embodiments 1 through 13, wherein the one or more relations of the one or more databases are source code elements of one or more source code bases.

Embodiment 15 is the method of any one of embodiments 1 through 14, further comprising: displaying on a display of a user device the ranked plurality of query results.

Embodiment 16 is a system comprising: one or more computers and one or more storage devices storing instructions that are operable, when executed by the one or more computers, to cause the one or more computers to perform the method of any one of embodiments 1 to 15.

Embodiment 17 is one or more computer-readable storage media encoded with instructions that, when executed by one or more computers, cause the one or more computers to perform operations comprising the method of any one of embodiments 1 to 15.

While this specification contains many specific implementation details, these should not be construed as limitations on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a query having a plurality of predicates;
executing the query on one or more relations of one or more databases to generate a plurality of query results, comprising executing the plurality of predicates to generate a plurality of tuple values;
generating a query derivation graph for the query, wherein the query derivation graph comprises:
nodes that each represent one or more distinct tuple values of the plurality of tuple values, and
edges between pairs of nodes, wherein each edge between a respective pair of nodes represents one or more predicates of the plurality of predicates of the query that generated tuple values corresponding to the respective pair of nodes connected by the edge, during the execution of the query;
generating, from the query derivation graph, a plurality of feature values for each query result of the plurality of query results;
computing a score for each query result of the plurality of query results by using the plurality of feature values generated for the query result as input to a trained ranking model; and
ranking the plurality of query results according to computed scores generated by the trained ranking model.

2. The method of claim 1, wherein generating, from the query derivation graph, the plurality of feature values for each query result of the plurality of query results comprises:
computing one or more properties of a query derivation subgraph for a particular query result in the plurality of query results.

3. The method of claim 2, wherein the one or more properties of the query derivation subgraph comprise graph metrics, wherein the graph metrics comprise one or more metrics for the nodes of the query derivation graph, the edges of the query derivation graph, or for relationships between the edges and the nodes of the query derivation graph.

4. The method of claim 3, wherein the one or more properties of the query derivation subgraph comprise a graph metric representing a number of times a particular predicate type was executed while executing the query to generate the particular query result.

5. The method of claim 3, wherein the one or more properties of the query derivation subgraph comprise a graph metric representing a number of nodes in the query derivation subgraph.

6. The method of claim 3, wherein generating, from the query derivation graph, the plurality of feature values for each query result of the plurality of query results comprises:
generating a graph embedding of the query derivation subgraph for the particular query result, wherein the graph embedding represents the one or more properties of the query derivation subgraph.

7. The method of claim 3, wherein the one or more properties of the query derivation subgraph comprise a graph metric representing a number of edges in the query derivation subgraph.

8. The method of claim 1, further comprising training the trained ranking model on labeled data obtained by:
executing the query on the one or more relations of the one or more databases to generate the plurality of query results, and
obtaining the labeled data as user feedback for each query result of the plurality of query results.

9. The method of claim 8, further comprising:
after executing the query on the one or more relations of the one or more databases to generate the plurality of query results:
obtaining the user feedback for each query result of the plurality of query results, and
updating weights of the trained ranking model using the user feedback.

10. The method of claim 9, further comprising:
after executing the query on the one or more relations of the one or more databases to generate the plurality of query results:
executing the query again on the one or more relations of the one or more databases to generate a plurality of second query results,
obtaining second user feedback for each second query result of the plurality of second query results, and
updating the weights of the trained ranking model using the second user feedback.

11. The method of claim 1, further comprising:
receiving a plurality of queries;
for each query in the plurality of queries, executing the query on the one or more relations of the one or more databases to generate a respective plurality of query results; and
for each query in the plurality of queries, computing a score for each query result of the respective plurality of query results for the query by using a respective plurality of feature values generated for the query result as input to a respective trained ranking model for the query.

12. The method of claim 1, wherein the trained ranking model is trained to generate scores for query results obtained from executing the query.

13. The method of claim 1, wherein computing a score for each query result of the plurality of query results by using the plurality of feature values generated for the query result as input to a trained ranking model comprises:
computing the score for each query result by a predicated relevance of each query result.

14. The method of claim 1, wherein the one or more relations of the one or more databases are source code elements of one or more source code bases.

15. The method of claim 1, further comprising:
displaying on a display of a user device the ranked plurality of query results.

16. A system comprising:
one or more computers and one or more storage devices storing instructions that are operable, when executed by the one or more computers, to cause the one or more computers to perform operations comprising:
receiving a query having a plurality of predicates;
executing the query on one or more relations of one or more databases to generate a plurality of query results, comprising executing the plurality of predicates to generate a plurality of tuple values;
generating a query derivation graph for the query, wherein the query derivation graph comprises:
nodes that each represent one or more distinct tuple values of the plurality of tuple values, and
edges between pairs of nodes, wherein each edge between a respective pair of nodes represents one or more predicates of the plurality of predicates of the query that generated tuple values corresponding to the respective pair of nodes connected by the edge, during the execution of the query;
generating, from the query derivation graph, a plurality of feature values for each query result of the plurality of query results;
computing a score for each query result of the plurality of query results by using the plurality of feature values generated for the query result as input to a trained ranking model; and
ranking the plurality of query results according to computed scores generated by the trained ranking model.

17. The system of claim 16, wherein generating, from the query derivation graph, the plurality of feature values for each query result of the plurality of query results comprises:
computing one or more properties of a query derivation subgraph for a particular query result in the plurality of query results.

18. The system of claim 17, wherein the one or more properties of the query derivation subgraph comprise graph metrics, wherein the graph metrics comprise one or more metrics for the nodes of the query derivation graph, the edges of the query derivation graph, or for relationships between the edges and the nodes of the query derivation graph.

19. The system of claim 16, wherein the operations further comprise training the trained ranking model on labeled data obtained by:
executing the query on the one or more relations of the one or more databases to generate the plurality of query results, and
obtaining the labeled data as user feedback for each query result of the plurality of query results.

20. One or more non-transitory computer-readable storage media encoded with instructions that, when executed by one or more computers, cause the one or more computers to perform operations comprising:
receiving a query having a plurality of predicates;
executing the query on one or more relations of one or more databases to generate a plurality of query results, comprising executing the plurality of predicates to generate a plurality of tuple values;
generating a query derivation graph for the query, wherein the query derivation graph comprises:
nodes that each represent one or more distinct tuple values of the plurality of tuple values, and
edges between pairs of nodes, wherein each edge between a respective pair of nodes represents one or more predicates of the plurality of predicates of the query that generated tuple values corresponding to the respective pair of nodes connected by the edge, during the execution of the query;
generating, from the query derivation graph, a plurality of feature values for each query result of the plurality of query results;
computing a score for each query result of the plurality of query results by using the plurality of feature values generated for the query result as input to a trained ranking model; and
ranking the plurality of query results according to computed scores generated by the trained ranking model.
